(19) United States
(12) Patent Application Publication
(10) Pub. No.: US 2026/0028146 A1
(43) Pub. Date: Jan. 29, 2026

(54) METHOD FOR CONTROLLING THE MOVEMENT OF AN OPERATING ASSEMBLY OF AN APPARATUS FOR THE AUTOMATIC PROCESSING OF ARTICLES

(71) Applicant: R.A JONES & CO., Covington, KY (US)

(72) Inventors: Andrea BIONDI, BOLOGNA (IT); Luca CAVAZZA, BOLOGNA (IT); Cristian DAKESSIAN, BOLOGNA (IT); Giacomo IMBRIACO, BOLOGNA (IT)

(21) Appl. No.: 18/998,480

(22) PCT Filed: Jul. 31, 2023
(86) PCT No.: PCT/IB2023/057771

§ 371 Date: Jan. 25, 2025

(30) Foreign Application Priority Data
Aug. 5, 2022 (IT) 102022000016881

(51) Int. Cl. B65B 43/50; B31B 50/00; B65B 35/26; B65B 43/46; B65B 57/00; B65B 57/04; B65B 57/18

(52) U.S. Cl. CPC B65B 43/50; B31B 50/006; B65B 35/26; B65B 43/46; B65B 57/005; B65B 57/04; B65B 57/18

(57) ABSTRACT

Page 2 Please replace the Abstract of the specification filed as follows:

A method for controlling the movement of an operating assembly of an apparatus for the automatic processing of articles includes defining, for at least one segment of the movement trajectory of the operating assembly, an acceptable deviation from the movement trajectory, such that the operating assembly can be moved in safe conditions, arranging an auxiliary guide element at a safety trajectory which is alongside the movement trajectory at a distance substantially equal to the deviation, and moving the operating assembly by means of at least one electric motor along said movement trajectory. If the operating assembly moves away from the movement trajectory by a distance equal to said deviation, the auxiliary guide element abuts the operating assembly, controlling its movement and guiding it along the safety trajectory.

The present invention relates to a method for controlling the movement of an operating assembly within an apparatus configured to automatically perform predetermined operations, typically of a cyclic nature, on generic articles.

The present invention has a preferred, though not exclusive, application in the field of product packaging in boxes.

The type of packaging and the type of products to be packaged remains entirely generic, but, by way of example and without thereby losing generality, it takes the form herein in a packaging process in boxes of products of variable geometry and which are and relatively delicate, such as bags of cercal flakes, by forming the box around the product to be packaged (a packaging procedure known in the field as ‘wrap-around’).

Such a packaging method involves the box being formed by wrapping a blank, e.g., shaped and creased cardboard, around a mandrel made of rigid material, e.g., metal, containing the product to be packaged. Such a mode provides that the blank is wrapped around the mandrel so as to form a box closed laterally but open at one end thereof, from which the mandrel is then extracted, leaving the article inside the newly formed box. The open end is then closed again, so that the resulting package can be sent to the final packaging steps and shipped to the point of sale.

In the present disclosure as well as in the claims enclosed herein, certain terms and expressions are deemed to have, unless otherwise expressly indicated, the meaning expressed in the following definitions.

The term ‘article’ means any object which can be processed in an automatic apparatus.

In the event of an apparatus for packaging products in boxes, article can indistinctly refer to the product to be packaged, or the box, either empty or containing the product to be packaged, or further, the semi-finished products from which the box or the product are obtained, such as a blank to be wrapped around the product in order to obtain the box.

The product to be packaged can have a predefined geometric shape or it can have a variable geometry, e.g., a bag containing incoherent material.

The products to be packaged can be food and confectionery articles, either loose or contained inside bags or other types of wrapping, such as bags of cereals or capsules of coffee or other infusion drinks, individual chocolates (wrapped or unwrapped), candies, pouches containing solid, liquid or semi-solid food products; in addition, they can be products from the ceramic industry, absorbent articles for sanitary use, products from the tobacco industry, products from the cosmetics industry, products from the pharmaceutical industry, products from the personal & home care industry.

‘Processing’ of an article means any operation which, as part of a transformation process, involves the interaction of an operating assembly of an automatic apparatus with the article in order to change one or more features thereof.

Examples of processing which can be performed on an article include changes in position or orientation (such as moving and retaining), changes in configuration (such as folding, forming, cutting, fixing, ablation), changes in composition (such as filling, washing, colouring).

Examples of operating assemblies of an automatic processing apparatus which perform a processing on an article are article gripping devices, e.g., of the gripper or suction cup type, article moving devices, e.g., trays or containers mounted on arms or carousels, such as a mandrel in a packaging process, cutting devices folding devices, such as an assembly which folds a blank around a mandrel to form a box, forming devices, such as a cylinder and piston type assembly configured to form a box or a thermoforming or deep-drawing assembly, coupling devices, such as a scaling or gluing assembly.

A movement, e.g., of an operating assembly, is defined by a law of motion which, for each point in the operating assembly, determines a position in space as a function of time. Consequently, the position, velocity and acceleration of each point of the operating assembly can be defined at any instant.

A ‘trajectory’ of a moving element (real or hypothetical), e.g., an operating assembly, is defined by the set of positions in space touched by the element during its movement.

A ‘deviation’ of an element, e.g., of an operating assembly, with respect to a predefined trajectory of such an element, e.g., a movement trajectory of an operating assembly, is defined as the non-zero distance of such an element from such a predefined trajectory.

In other words, there is a deviation when the element, during its movement, is located in a point outside the predefined trajectory, whereas there is no deviation when the element, during its movement, is located on the predefined trajectory. A movement of an operating assembly is performed in “safe conditions” when such a move is conducted without causing damage to the automatic processing apparatus or the article being processed or to the operator or the environment.

A deviation of an operating assembly with respect to its predefined movement trajectory is ‘acceptable’ when it allows the movement of the operating assembly to occur in safe conditions.

‘Packaging’ of one or more products in a box means obtaining a box containing said one or more products. Such packaging can be obtained by inserting one or more products into an already formed box or, preferably, it can be obtained by forming a box around the one or more products to be contained.

‘Mandrel’ means a container capable, on the one hand, of receiving and supporting the product to be packaged and, on the other hand, of providing an effective abutment for folding the blank when wrapped around the same.

For this purpose, it should be noted that the receipt and support of the product do not in themselves imply that the product must be fully accepted within the mandrel or completely supported by it, but it is sufficient that it is so at the moment when the blank is wrapped around the mandrel.

Similarly, it should be noted that the abutment of the blank also does not in itself imply that the blank must be abutted over its entire surface area by the mandrel, but it is sufficient that it is so to the extent necessary to allow for the correct folding required to form the box.

The mandrel can consist of ‘separate portions’, such an expression meaning distinct mandrel portions which are not directly connected to each other, and preferably movable independently of each other.

A first element ‘abuts’ a second element when the first element touches the second element and is capable of at least partially opposing a relative movement of the first clement against the second element.

‘Blank’ means a shaped sheet of suitable material and thickness, adapted to be wrapped by means of folding around a mandrel to form a box.

Preferably, the blank is made of cardboard and is provided with creases or other zones of weakened material (such as incisions, perforations, etc.) capable of favouring the folding of the cardboard at predefined folding lines.

‘Box’ means any container adapted to contain a plurality of products for the purpose of their packaging, which can be made from a blank by folding around a mandrel and subsequent fixing at its edges or panels.

Preferably, the box has at least one closed contour section, more preferably it is closed laterally around the mandrel while the longitudinal ends are kept open.

The Applicant has preliminarily observed that in the production processes of articles by means of automatic processing apparatuses, such as a packaging process of products in boxes such as that referred to above, it is provided that one or more operating assemblies configured to interact with the articles are required to perform movements between one or more working positions following laws of motion which are sometimes very complicated.

The general and constant need to increase more and more the production capacity of production plants also requires that such movements are often performed at very high speeds.

The Applicant has further verified that the movement of an operating assembly must also ensure a high precision of the movements, both in spatial and in temporal terms, in particular when such an operating assembly is called upon to cooperate with other operating assemblies in a synchronised manner.

In fact, the Applicant has observed that an incorrect movement of the operating assembly can cause even significant accidents with damage to both the articles being processed and the processing apparatus itself, even with the risk of repercussions on the environment and the operators.

The Applicant has also noted that the movement of the operating assemblies must not only be precise but also fully repeatable and reliable over time, so as to ensure the absence of undesirable accidents for processing periods which are as long as possible, and not require frequent scheduled maintenance.

Compliance with the requirements of precision and reliability in the movement of operating assemblies is therefore particularly critical, as these requirements not only involve very important aspects from an economic point of view, both in terms of production continuity and quality, as well as apparatus efficiency and integrity, but also from a safety point of view.

The Applicant has further noted that, in very general terms, the movement in space of an operating assembly, or of one or more components of the operating assembly, along respective and specific trajectories following corresponding and specific laws of motion, can be obtained using mainly two movement systems.

The first system involves the use of cam mechanisms, while the second system involves the use of electric motors.

In the first system, the movement of the operating assembly, or of one or more components thereof, is obtained thanks to the provision of suitable mechanical couplings between the operating assembly (or a component thereof) to be moved and a main movement unit. In particular, such couplings involve the direct contact between a cam profile, generally integral with the main movement unit, and a cam-follower element connected, also by means of complex articulated systems, to the operating assembly to be moved.

Thereby, the basic motion induced by the main movement unit, which can be for example a rotational motion around a fixed axis, is transformed into a derived motion of the operating assembly.

The Applicant has verified that by suitably sizing the cam profile and the articulated connection system, it is possible to obtain even very complex and, above all, very precise and reliable movements over time.

However, the Applicant has verified that the cam-mechanism movement system becomes difficult to manage when the production process requires changes to the law of motion or to the trajectory of the operating assembly. In fact, in these cases, either the cam profile or the connection system between the cam and the operating assembly must be modified, and these operations can also require long and costly interventions, resulting in production losses due to ‘downtime’, without considering the possible need for manual intervention by the operator and the need to find and stock additional or replacement mechanical components.

On the other hand, in some production processes the need to change the laws of motion and trajectories of one or more operating assemblies can be particularly frequent, so that the need to simplify operations to modify such operating parameters, which allow in particular to minimise machine downtime, operator interventions and the provision of spare parts, also becomes critical.

An example of production processes of the type described above can be represented by a product packaging process in boxes, where frequent ‘format changes’ of the product to be packaged and/or the box to be formed can be envisaged.

In the second movement system mentioned above, the movement of the operating assembly, or of one or more components thereof, is obtained thanks to the action of one or more electric motors, coupled to the element to be moved either directly or by means of actuator or transmission systems. In other words, the movement of the operating assembly or of a component thereof is controlled directly by a special motor, and is thus essentially independent of the other movements.

The Applicant has verified that this second movement system advantageously allows great operating flexibility, with the ability to set and modify the action of each electric motor in a relatively simple manner and, consequently, the laws of motion and trajectories of the operating assembly connected thereto.

The Applicant has therefore found that the adoption of the second movement system effectively meets the need for rapid and frequent changes in operating parameters involving the laws of motion and trajectories of the operating assemblies.

However, the Applicant has also verified that the movement system of the operating assemblies by means of electric motors does not ensure the degree of reliability which is inherent in cam mechanisms.

In particular, the Applicant has found that over time, the electric motors can have small spatial and temporal misalignments, which can increase the possibility of potential accidents.

The Applicant has therefore felt the need to make for a movement system which could simultaneously meet both the requirements of high operating flexibility and the demands of high movement precision and reliability.

On the other hand, the Applicant has noted that the two movement systems are not compatible with each other and do not allow mutual integrations so that an operating assembly cannot be moved simultaneously with both electric motors and with a cam mechanism.

However, the Applicant has perceived that a suitably revised and modified cam-driven movement system could be used as an auxiliary guide system, called upon to act in the movement of the operating assembly only following a malfunction of the electric motor movement system.

Thereby, a main movement system, of the electric motor type, is defined which is assigned to move the operating assembly during the normal operation thereof with predefined trajectory and law of motion, and an auxiliary movement system, of the cam type, which is assigned to ensure the correct movement of the operating assembly in the event of a malfunction of the main movement system.

The Applicant has lastly found that the movement of an operating assembly of an automatic article processing apparatus, in which the movement of the operating assembly along a defined movement trajectory to perform a processing on the article is operated by one or more electric motors and in which the movement trajectory, in at least one segment thereof, is flanked by an auxiliary guide element placed at such a distance as to allow the movement of said operating assembly in safe conditions, ensures on the one hand a high degree of flexibility in normal operating conditions, resulting from the use of electric motors, and on the other hand, great reliability and a high degree of safety in malfunctioning conditions, deriving from the provision of the auxiliary guide element.

Therefore, in a first aspect thereof, the present invention relates to a method for controlling the movement of an operating assembly of an apparatus for the automatic processing of articles.

Preferably, said operating assembly is configured to perform a processing on said article.

Preferably, such a method comprises the step of defining a movement trajectory for said operating assembly.

Preferably, such a method comprises the step of defining, for at least one segment of said movement trajectory, an acceptable deviation of said operating assembly from said movement trajectory.

Of course, said acceptable deviation is non-zero.

Preferably, said deviation is acceptable when it allows the movement of said operating assembly in safe conditions.

Preferably, such a method comprises the step of defining, in said at least one segment of said movement trajectory, a safety trajectory alongside said movement trajectory at a distance substantially equal to said deviation.

Preferably, such a method comprises the step of configuring at least one electric motor to move, at least partially, said operating assembly along said movement trajectory.

Preferably, such a method comprises the step of arranging an auxiliary guide element at said safety trajectory.

Preferably, such a method comprises the step of moving said operating assembly, at least partially, by means of said at least one electric motor along said movement trajectory.

Preferably, if along said at least one segment of movement trajectory, said operating assembly moves away from said movement trajectory by a distance equal to said deviation, said method comprises the step of abutting said operating assembly with said auxiliary guide element so as to control the movement of said operating assembly by guiding it along said safety trajectory by means of said auxiliary guide element.

Thanks to these features, the control method proposed by the present solution allows to move the operating assembly of the automatic article processing apparatus in conditions of absolute safety and, at the same time, great operational flexibility.

In particular, the laws of motion of the operating assembly can be varied relatively quickly by changing the settings of one or more of the electric motors controlling it.

It should be noted that a change in the law of motion can leave the motion trajectory unchanged, or in some cases, it can change it in some of its segments.

The control method offered by the present solution also advantageous allows to identify the most critical segments within the movement trajectory from the point of view of the overall safety of the processing process, and to arrange an auxiliary guide clement only at such critical segments. Thereby, the provision of the auxiliary guide element can be limited to only certain zones of the apparatus, obtaining significant savings in terms of construction costs, material and space requirements, as well as greater freedom to change the movement trajectory in other regions of the apparatus, if necessary.

It should also be noted that the control method offered by the present solution allows to move the operating assembly in conditions of deviation from the predefined movement trajectory, along a safety trajectory which follows a specifically predetermined, non-random path.

In other words, the auxiliary guide element is configured to provide a cam profile which guides the operating assembly in a predefined manner so as not to cause damage to the article, the apparatus, the environment or the operator.

This feature profoundly distinguishes the auxiliary guide element from the protective barriers commonly used in operating machines with moving parts.

In fact, the latter have the function of preventing the moving part from exiting a certain boundary surface, i.e., to contain the moving part, without worrying about the path followed by the part of the operating machine after hitting the protective barrier. In other words, a moving part of an operating machine which hits a protective barrier then follows a random, non-predetermined trajectory and is in no way guided by the protective barrier it hit.

In a second aspect thereof, the present invention relates to an apparatus for the automatic processing of articles.

Preferably, said apparatus comprises an operating assembly configured to interact with said article to perform said processing.

Preferably, said operating assembly can be moved along a predefined movement trajectory.

Preferably, said apparatus comprises at least one electric motor, configured to move, at least partially, said operating assembly along said movement trajectory.

Preferably, said apparatus comprises an auxiliary guide element alongside said movement trajectory, at at least one segment thereof.

Preferably, said auxiliary guide element is spaced from said movement trajectory by a distance equal to an acceptable deviation of said operating assembly from said movement trajectory, such that said operating assembly can be moved in safe conditions.

Preferably, said auxiliary guide clement is configured to abut said operating assembly when said operating assembly moves away from said movement trajectory by a distance equal to said deviation.

Preferably, said auxiliary guide element is configured to guide said operating assembly along a safety trajectory defined by said auxiliary guide element.

Thanks to these features, the apparatus for the automatic processing of articles according to the present solution is capable of moving an operating assembly, controlling its movement effectively and safely.

The auxiliary guide element can be any mechanical element capable of abutting an operating assembly in motion and guiding it along a predefined trajectory. In particular, the auxiliary guide clement can be suitably shaped so as to have a cam profile defining such a predefined trajectory.

Examples of auxiliary guide elements are plates, brackets, ramps or chutes made of material sufficiently rigid to abut the operating assembly in motion without appreciable deformations, e.g., metal material.

In a further aspect thereof, the present solution relates to an apparatus for the automatic processing of articles, comprising an operating assembly configured to perform one or more processes on articles along a predefined movement trajectory and an auxiliary guide element of the operating assembly.

Preferably, the auxiliary guide element comprises a guide surface and has a passive operating mode in which the auxiliary guide element is at a predetermined distance from the predefined movement trajectory of the operating assembly and does not interact with the operating assembly when the operating assembly is along the predefined movement trajectory or deviates from the predefined movement trajectory by a distance less than the predetermined distance, as well as an active operating mode in which the auxiliary guide clement guides the operating assembly along a safety trajectory which is different from the predefined movement trajectory, for example when the operating assembly deviates from the predefined movement trajectory by a distance corresponding to the predetermined distance, and in which the safety trajectory is defined by the shape of the guide surface and extends following said shape.

In a further aspect thereof, the present solution relates to an apparatus for the automatic processing of articles, comprising an operating assembly configured to perform one or more processes on articles along a predefined movement trajectory and a main guide clement of the operating assembly, configured to move, at least partially, the operating assembly along the predefined movement trajectory.

Preferably, said apparatus further comprises an auxiliary guide element of the operating assembly, arranged at a predetermined distance from the predefined movement trajectory of the operating assembly and comprising a guide surface shaped so as to provide a safe trajectory for the operating assembly.

Preferably, the auxiliary guide clement is configured to move, as an alternative to the main guide element, the operating assembly along the safety trajectory when the operating assembly deviates from the predefined movement trajectory by a distance corresponding to the predetermined distance.

In a further aspect thereof, the present solution relates to a method for the automatic processing of articles by an operating assembly, comprising:
a) predefining a movement trajectory of the operating assembly for processing articles;
b) predefining a maximum deviation distance of the operating assembly from the movement trajectory when processing articles;
c) predefining a safety trajectory of the operating assembly for processing articles,
d) not interfering with the trajectory of the operating assembly when processing articles if the trajectory corresponds to the movement trajectory or deviates from the movement trajectory by a distance less than the maximum deviation distance, and
e) interfering with the trajectory of the operating assembly when processing articles by moving the operating assembly along the safety trajectory as soon as the trajectory deviates from the movement trajectory by a distance equal to the maximum deviation distance.

The present solution, in at least one of the aforesaid aspects, can have at least one of the further preferred features set forth below.

In some embodiments, said operating assembly is moved along at least said segment of the movement trajectory only by said at least one electric motor.

In a first embodiment, the movement of the operating assembly along the movement trajectory is completely determined by the action of one or more electric motors, directly with interposition of motion transmission systems, but without provision for further movement mechanisms, in particular cam mechanisms.

In other embodiments, said movement trajectory of said operating assembly is defined, in at least said segment, by the combination of several movements, at least one of which is defined only by said at least one electric motor.

In this case, one of the movements which combined together define the movement trajectory of the operating assembly can also be obtained with a drive mechanism other than an electric motor, e.g., defined by a cam mechanism, while at least one of the remaining movements is defined only by one or more electric motors.

For example, the movement trajectory of an operating assembly can be defined by the combination of a rotational movement of a drum around the axis thereof, determined by a first electric motor, a radial translation movement, determined by a cam mechanism, of an equipment mounted on the drum, and an axial translation movement of the operating assembly mounted on the equipment, determined by a second electric motor.

In some embodiments, said deviation is variable based on the position of said operating assembly along said at least one segment of the movement trajectory.

Thereby, with the correct identification of the acceptable deviation from the movement trajectory, the safety trajectory can be precisely and punctually defined, so that the auxiliary guide clement can be optimally configured and positioned, ensuring the precision of the movement at the most critical points of the movement trajectory without, however, placing unnecessary constraints on the movement in less critical zones.

In some embodiments, said deviation is variable based on a deviation direction of said operating assembly from said movement trajectory.

Thereby, the definition of the safety trajectory can be determined even more precisely. In fact, the Applicant has observed that the acceptable deviation from the movement trajectory can not only vary from point to point, but, at the same point, can also vary according to the direction along which the operating assembly moves away from the movement trajectory.

In some embodiments, said acceptable deviation is the maximum deviation which can be used to move the operating assembly in safe conditions.

Thereby, the margin of error allowed for the movement of the operating assembly is as large as possible. Moreover, this aspect advantageously allows the original movement trajectory to also be modified if necessary, for example to adapt the automatic processing apparatus to new operating requirements (dictated for example by new articles or new processing processes).

It should be noted that any acceptable deviation is equal to or less than the maximum deviation.

In some embodiments, said maximum deviation is given by the minimum distance of said movement trajectory from another component of said apparatus.

Said other component of the apparatus, in turn, can be fixed or moving.

In some embodiments, said deviation is less than 100 mm, in other embodiments it is less than 50 mm.

In some embodiments, said deviation is greater than 1 mm, in other embodiments it is greater than 3 mm.

Preferably, the movement trajectories of the operating assembly are stored in a control unit of the processing apparatus.

Preferably, the control unit controls said electric motor so as to control the movement of the operating assembly along the movement trajectory.

In some embodiments, the control unit allows the movement trajectory of the operating assembly to be changed.

In some embodiments, the method comprises the step of detecting when said operating assembly is abutted by said auxiliary guide element.

It is thereby possible to immediately understand when the operating assembly deviates from the movement trajectory by a distance which is considered excessive and thus potentially dangerous.

In some embodiments, following said detection, a step is provided for sending an alarm signal when said operating assembly is abutted by said auxiliary guide element.

The alarm signal can be acoustic or luminous and can be displayed on a control monitor of the processing apparatus. Based on the alarm signal, the operator can intervene promptly and put immediate corrective measures in place.

In some embodiments, following said detection, a step is provided of stopping the movement of said operating assembly, preferably stopping said apparatus.

Preferably, the machine stop occurs automatically without operator intervention.

Preferably, the machine stop occurs in a controlled manner, in which a control unit stops the various components of the apparatus according to predefined modes, sequences and times, which on the one hand ensure short stopping times and on the other stop in safe conditions.

In some embodiments, such detection comprises measuring an operating parameter of said electric motor and comparing the measured value of said operating parameter with a standard value of said operating parameter.

Preferably, said operating parameter is the electric power absorbed by the electric motor or the force torque applied by the electric motor.

In some embodiments, said operating assembly is mounted on an equipment of said apparatus.

Preferably, said equipment is movable with respect to a load-bearing structure of said apparatus.

Preferably, said method comprises the step of moving said equipment along a main trajectory.

Preferably, said method comprises the step of moving said operating assembly with respect to said equipment while said equipment is moved along said main trajectory.

Thereby, the movement trajectory of the operating assembly can result from the combination of two distinct movements, that of the equipment with respect to the load-bearing structure of the apparatus and that of the operating assembly with respect to the equipment on which it is mounted.

In some embodiments, the main trajectory is circular.

However, it is envisaged that said main trajectory can have different shapes, for example rectilinear, annular or elliptical.

In some embodiments, said operating assembly is moved with respect to said equipment by means of translation movement.

However, it is envisaged that said operating assembly is moved by means of rotational or roto-translational movements.

In some embodiments, said load-bearing structure is fixed.

In some embodiments, said equipment rotates around a rotation axis, preferably fixed and preferably passing through said load-bearing structure.

In some embodiments, a plurality of equipment is mounted on said load-bearing structure, and preferably each equipment is provided with a respective operating assembly.

In some embodiments, said auxiliary guide element is integral with said load-bearing structure.

Thereby, the weight of the auxiliary guide element does not increase the mass to be moved, limiting the impact on the production and operating costs of the apparatus.

In some embodiments, said operating assembly comprises an abutment element intended to abut said auxiliary guide element when said operating assembly moves away from said movement trajectory by a distance equal to said deviation.

It is thereby possible to specifically and optimally configure the part of the operating assembly which is intended, if necessary, to abut the auxiliary guide element.

Preferably, a portion of the surface is identified on said auxiliary guide element which is intended to abut, if necessary, said abutment element, so as to act as a cam profile for the movement of said operating assembly along said safety trajectory.

In some embodiments, said abutment element comprises a roller configured to roll on said auxiliary guide element.

The abutment element can thus advantageously act as a follower element of the cam profile defined on the auxiliary guide element.

In some embodiments, said abutment element is integrally connected to a main unit of said operating assembly configured to perform said processing on said article.

In other embodiments, said abutment element is connected by means of a system of articulated rods to a main unit of said operating assembly configured to perform said processing on said article.

It is thereby possible to obtain more complex movements of the operating assembly.

In other embodiments, said auxiliary guide element comprises a slide channel.

Preferably, each wall of said slide channel is arranged at a distance from said movement trajectory equal to said acceptable deviation along a defined deviation direction between said movement trajectory and said wall.

Preferably, said abutment element is accommodated within said slide channel.

In some embodiments, said apparatus is an apparatus for packaging products in boxes, preferably of the ‘wrap-around’ type.

Preferably, said apparatus for packaging products in boxes comprises a mandrel configured to accommodate one of said products and around which a blank is wrapped in order to form said boxed product.

In some embodiments, said operating assembly comprises said mandrel.

Preferably, said mandrel is formed by a plurality of separate portions which are movable with respect to one another along respective movement trajectories between an operating position, in which said portions form said mandrel, and a non-operating position in which said mandrel is broken down.

In some embodiments, said operating assembly comprises a closing device arranged to at least partially overlap and fix an outer flap of a blank onto an inner flap of the same blank when the blank is at least partially wrapped on a mandrel.

Preferably, said closing device comprises an abutting element and said closing device is movable along a movement trajectory between a non-operating position, in which said abutting element is in a remote position with respect to said mandrel, and an operating position, in which said abutting clement is in a position to press said outer flap onto said inner flap and against said mandrel.

In some embodiments, said operating assembly comprises a retaining device movable along a movement trajectory between a non-operating position in which said retaining device is spaced from said mandrel and an operating position in which said retaining device is abutted to said mandrel to retain said blank against said mandrel.

It should be noted that some steps of the method described above can be independent of the order of execution reported. Furthermore, some steps can be optional. Furthermore, some steps of the method can be performed repetitively, or can be performed in series or in parallel with other steps of the method.

The features and advantages of the present solution will become clearer from the detailed description of an embodiment shown, by way of non-limiting example, with reference to the appended drawings in which:

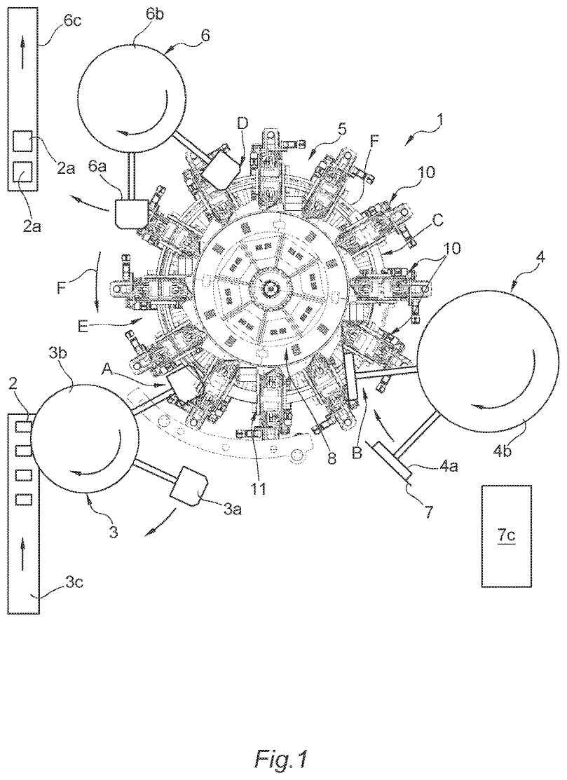

FIG. 1 is a schematic plan view from above of an apparatus for packaging products in boxes representing an apparatus for the automatic processing of articles in accordance with the present solution;

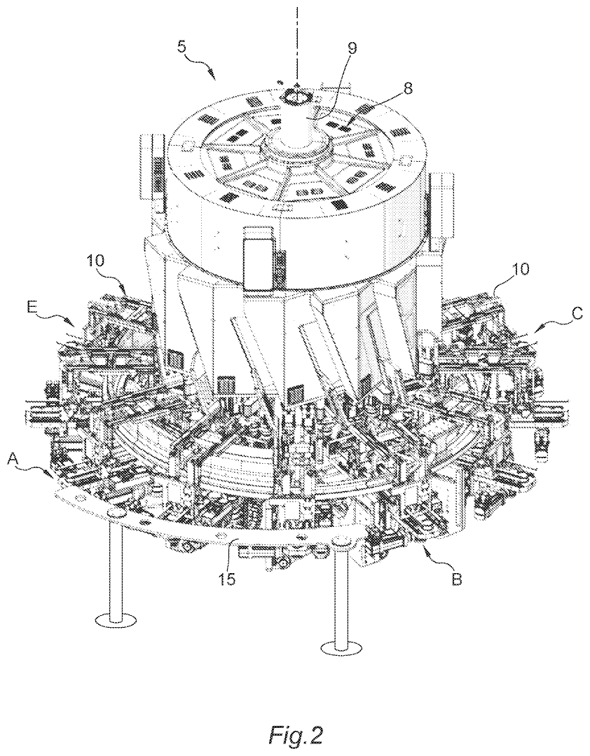

FIG. 2 is a partial schematic and perspective view from above of a unit of the packaging apparatus of FIG. 1;

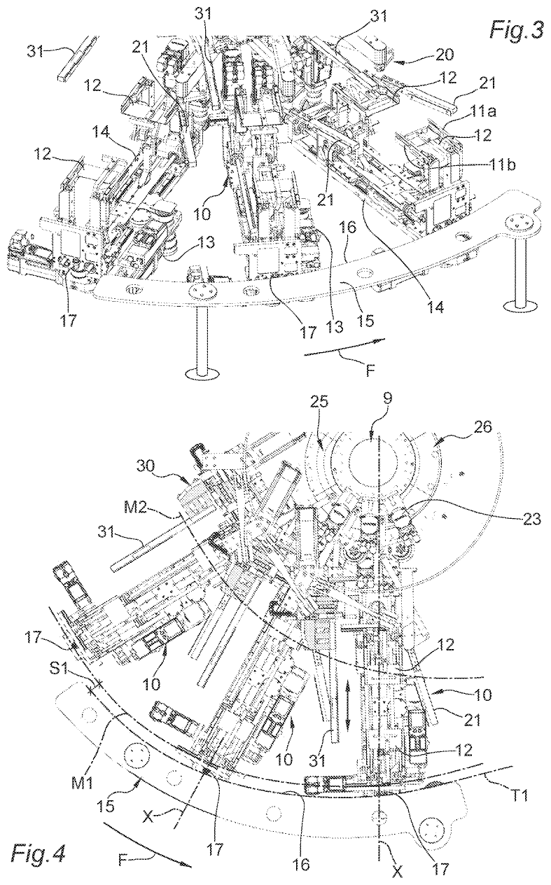

FIG. 3 is a perspective view and in enlarged scale view of a first example of an operating assembly of the packaging apparatus of FIG. 1, in successive operating positions;

FIG. 4 is a plan view from above of the operating assembly of FIG. 3 in the same successive operating positions;

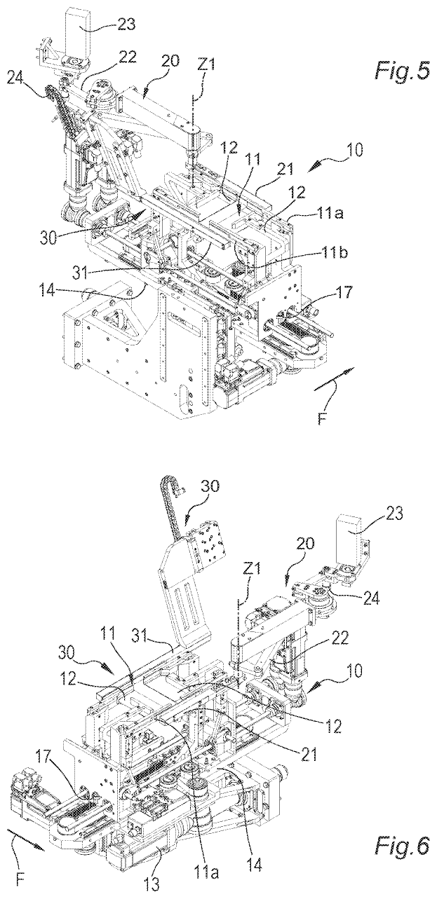

FIGS. 5 and 6 are schematic views in a perspective from one side and from the other of an equipment of the packaging apparatus of FIG. 1 with the operating assemblies in operating positions;

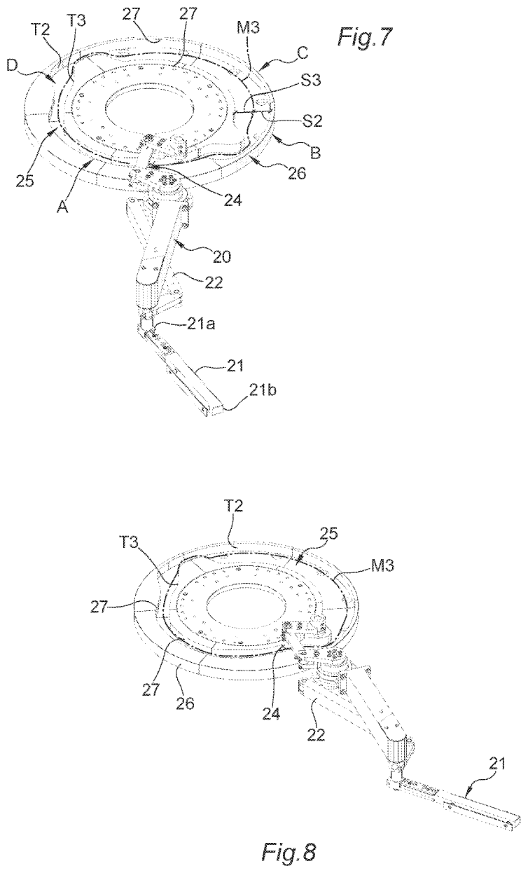

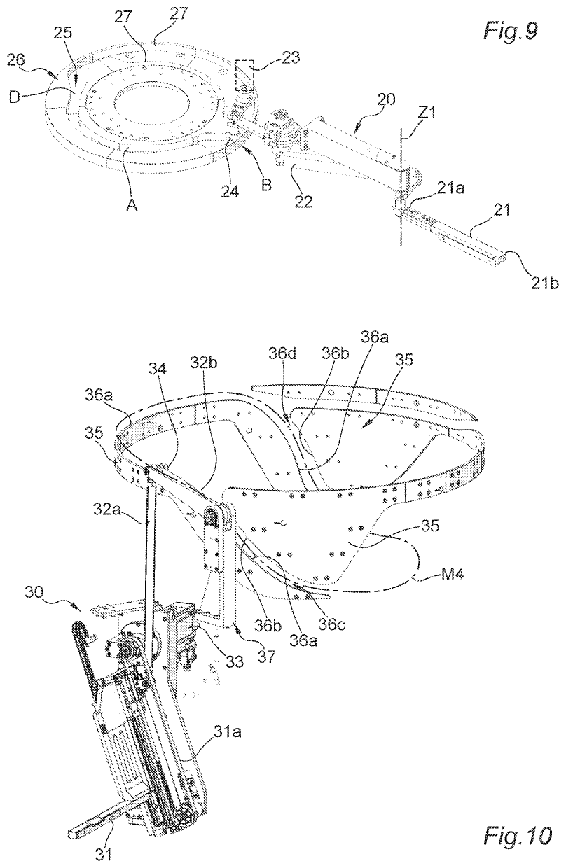

FIGS. 7 to 9 are schematically perspective views of a second example of an operating assembly of the packaging apparatus of FIG. 1, in successive operating positions;

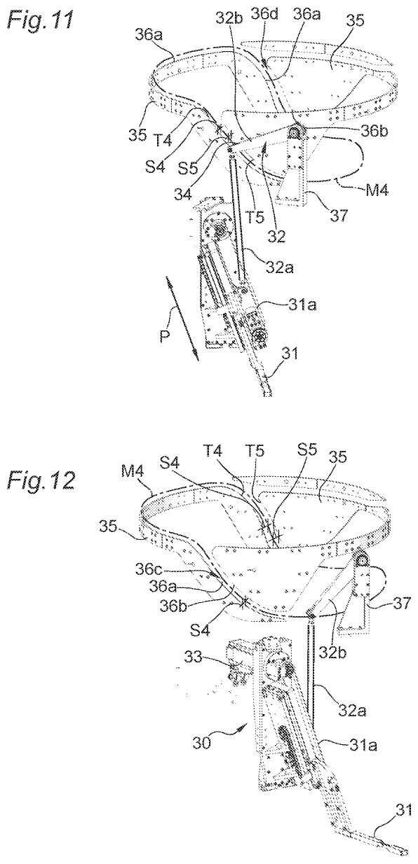

FIGS. 10 to 12 are schematic perspective views of a third example of an operating assembly of the packaging apparatus of FIG. 1, in successive operating positions;

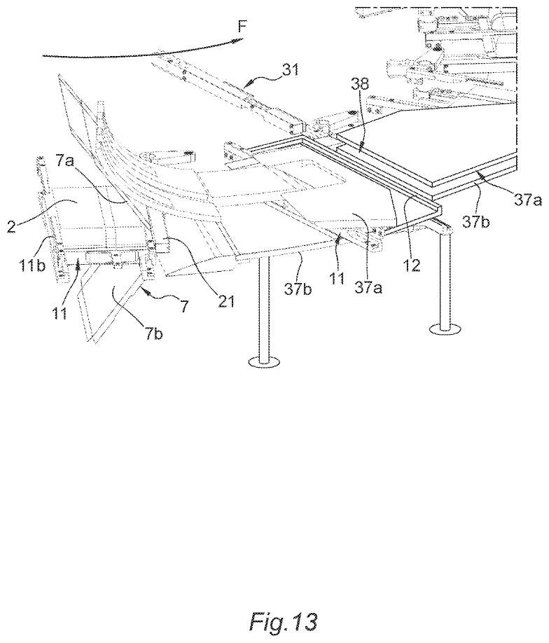

FIG. 13 is a schematic view in enlarged scale of a detail of the packaging apparatus of FIG. 1.

With reference to the enclosed figures, 1 globally refers to a packaging apparatus made in accordance with the present solution.

The packaging apparatus 1 is arranged to package one or more products 2 inside boxes formed from a blank. In particular, the packaging apparatus 1 is of the ‘wrap-around’ type and involves the box being formed around a mandrel containing the product to be packaged.

The individual products to be packaged, the blanks used to form the boxes, the formed boxes, open or closed, empty or containing one or more products to be packaged, represent, individually or jointly, a generic article processed by the packaging machine 1.

The products 2 to be packaged are, in this embodiment example, bags of granular, loose food products, e.g., cereal flakes.

With reference to FIG. 1, the packaging apparatus 1 comprises, in its most general units, a product feeder 3, a blank feeder 4, a packaging unit 5, and an unloading station 6.

The product feeder 3 can be made in any suitable form adapted to pick up a product 2 from an upstream work station (or from a conveyor 3c) and deliver it to the packaging unit 5. For example, the product feeder 3 can comprise a plurality of gripping devices 3a, e.g., of the gripper or suction cup type, mounted on a carousel 3b with a vertical axis.

The blank feeder 4, in turn, is configured to pick up a single blank 7 from a group of blanks stacked in a hopper 4c and bring it in the packaging unit 5. For example, the blank feeder 4 can comprise a plurality of griping members 4a, e.g., of the gripper or suction cup type, mounted on a carousel 4b rotatable about a vertical axis.

The packaging unit 5 is arranged to receive the products 2 from the product feeder 3 and form a box therearound starting from a blank 7 supplied by the blank feeder 4.

For this purpose, the packaging unit 5 comprises a plurality of equipment 10 all mounted on a carousel 8, rotatable about a vertical axis, so as to be continuously moved along a substantially circular path F.

Thereby, each equipment 10 is conducted with continuous motion along the circular path F between a receiving zone A, in which the equipment 10 receives a product 2 from the product feeder 3, an abutment zone B, in which the equipment 10 abuts a blank 7 supplied by the blank feeder 4, a forming zone C, in which the blank 7 is folded so as to form a box containing the product 2, an unloading zone D, in which the box 2a containing the product 2 is delivered to the unloading station 6, and lastly, a return zone E in which the equipment 10 is returned to the receiving zone A.

The unloading station 6 comprises, in turn, a plurality of gripping members 6a, e.g., gripper or suction cups, mounted on a carousel 6b with a vertical axis and arranged to pick up the box 2a containing the product 2 from the equipment 10 and move it onto an outlet conveyor 6c for the successive work steps.

Each equipment 10 comprises a mandrel 11, representing a first example of an operating assembly according to the present solution.

Each mandrel 11 is configured to accommodate a product 2 therein and to offer a suitable abutment to a blank which is folded around the mandrel 11 so as to form the box 2a containing the product 2.

With reference to the direction of movement along the circular path F, the mandrel 11 has a front wall 11a, a rear wall 11b as well as an upper wall and a lower wall.

In the embodiment described herein, the mandrel 11 consists of two distinct and separate portions 12, both mounted on an arm 14 radially extended from a load-bearing structure 9 of the carousel 8. The load-bearing structure 9 is fixed while the arms 14 of the equipment 10 are mounted thereon with the ability to rotate around the vertical axis of the carousel 8.

The two portions 12 are substantially identical to each other and each represent a respective half of the mandrel 11 and are arranged facing each other along a radial direction X of the carousel 8.

Each equipment 10 further comprises an electric motor 13 configured to move the two portions 12 with respect to each other between an operating position, in which the two portions 12 are brought closer together to form the mandrel 11, and a non-operating position, in which the two portions 12 are moved away from each other so as to break down the mandrel 11.

In the embodiment described and illustrated herein, the two portions 12 are brought closer together at a distance of approximately 60-140 mm, but it is also envisaged that, in alternative embodiments, the two portions 12 are brought closer together until they touch. In any case, the mandrel 11 is capable of accommodating and supporting the product to be packaged as well as providing an effective abutment for folding the blank when wrapped therearound.

The two portions 12 are moved between the operating and non-operating position by sliding along the arm 14, and are therefore moved closer and farther apart by moving along the radial direction X of the carousel 8.

In particular, the two portions 12 are moved by the electric motor 13 from the non-operating position to the operating position when the equipment 10 is about to arrive at the reception zone A, so that the mandrel 11 is already composed before receiving the product 2.

The two portions are held in the operating position while the equipment 10 travels the abutment zone B and the forming zone C, so as to allow the formation of a box closed laterally but open at the opposite longitudinal ends around mandrel 11.

In the unloading zone D, the two portions 12 are moved to the non-operating position, moving them away from each other along the radial direction X so that they completely exit the longitudinal ends of the box.

Once the two portions 12 have exited, the box 2a containing the product 2 is picked up by the gripping members 6a of the unloading station 6 to be sent to the next work stations, where the box 2a is also closed at its longitudinal ends and brought to the final steps of packaging and shipping.

The equipment 10 continues its circular path F in the return zone E where the two portions 12 are again brought closer together (in operating position) before again reaching the initial reception zone A.

The movement trajectories of the two portions 12, indicated in FIG. 4 respectively by M1 for the radially outer portion 12 and by M2 for the radially inner portion 12, are therefore the result of the composition of the circular motion of the equipment 10 around the vertical rotation axis of the carousel 8 (uniform circular motion) with the translation motion performed by the electric motor 13 which moves the two portions 12 on the equipment 10 between the operating and the non-operating position along the radial direction X.

The movement of the two portions 12 in the operating position before the feed zone A and especially before the abutment zone B is considered particularly critical. In fact, if for some reason the radially outer portion 12 were to remain in its non-operating position when the equipment 10 reaches the abutment zone B, the radially outer portion 12 could collide with a gripping member 4a of the blank feeder 4, causing possible damage to the packaging apparatus 1 and a potentially dangerous situation.

To prevent such an undesirable event, a first auxiliary guide element 15, fixed directly to the ground, such as the load-bearing structure 9 of the carousel 8, is provided between the feed zone A and the abutment zone B, radially outside the movement trajectory M1.

The first auxiliary guide element 15 is alongside the movement trajectory M1 at a distance S1 which, point by point, is equal to an acceptable deviation of the radially outer portion 12 with respect to the movement trajectory M1.

The deviation S1 represents the distance that the radially outer portion 12 can have from the movement trajectory M1 without incurring possible collisions with other components of the packaging apparatus, in particular the product feeder 3.

The deviation S1 can be comprised between a few millimetres (3-5 mm) and a few hundred millimetres (100-200 mm).

On the first auxiliary guide element 15, a radially inner cam surface 16 is defined facing the portion 12 and susceptible to abutting an abutment element, for example a roller 17, with a vertical axis, mounted idle directly at the radially outer end of the portion 12.

If, as depicted in FIGS. 3 and 4, the radially outer portion 12 should deviate from the movement trajectory M1 along the radial direction X away from the rotation axis of the carousel 8 (e.g., due to an insufficient movement of the electric motor 13 or a delay in such a movement) by a distance equal to the deviation S1, the roller 17 touches the cam surface 16 and the portion 12 is guided by the first auxiliary guide element 15 towards the other portion 12, along a predefined safety trajectory T1 which allows to avoid any possible collision with the product feeder 3.

The safety trajectory T1 is thus configured to guide the movement of the radially outer portion 12 in safe conditions and, in this case, substantially coincides with the trend of the cam surface 16.

During the normal operation of the packaging apparatus 1, the portions 12 are moved along the movement trajectory M1 and M2 only by the rotary movement of the carousel 8 and the radial translation along the arm 14 which is controlled by the electric motor 13, without any interaction with the first auxiliary guide element 15.

In fact, the latter would only intervene if the radially outer portion 12, e.g., due to some malfunction of the electric motor 13, did not move towards the operating position when the equipment 10 is located between the feed zone A and the abutment zone B.

In this case, moreover, it is envisaged that the contact between the portion 12 and the first auxiliary guide clement 15 is promptly detected, for example by monitoring an abnormal trend in the power absorbed by the electric motor 13 or in any other convenient manner. Following this detection, an alarm signal can be conveniently emitted and, preferably, a controlled shutdown of the packaging apparatus 1 can also be commanded, so that operators can perform the relevant checks and any maintenance.

A retaining device 20 is also mounted on each equipment 10, which is movable between a non-operating position, in which the retaining device 20 is spaced from the mandrel 11, and an operating position, in which the retaining device 20 is abutted to the mandrel 11 to retain a blank 7 against the mandrel 11 (FIGS. 5 and 6).

The retaining device 20 comprises a rod 21 positioned downstream of the mandrel 11 and articulated at a proximal end 21a to oscillate about a vertical axis Z1 which is fixed with respect to the equipment 10 between the operating position, in which the rod 21 is abutted to the front wall 11a of the mandrel 11, and the non-operating position, in which the rod 21 is spaced from the mandrel 11, tilting it with respect to the front wall 11a so that the distal end 21b thereof is moved away from the mandrel 11.

The oscillation of the rod 21 about the axis ZI is controlled by an electric motor 23, also mounted on the equipment 10, which acts on the rod 21 by means of an articulated rod system 22, e.g., levers and connecting rods.

An abutment element, formed by a roller 24 mounted idle on the articulated rod system 22, is accommodated within a second auxiliary guide element obtained in the load-bearing structure 9 of the carousel 8.

In particular, the second auxiliary guide element is formed by a variable-width slide channel 25 obtained on a circular plate 26, which is essentially horizontal, fixed to the load-bearing structure 9.

Furthermore, roller 24 is mounted at a joint of a pair of articulated rods of the articulated rod system 22, preferably coaxially with such a joint.

The retaining device 20 described herein represents a second example of an operating assembly according to the present solution, in which the rod 21 (which retains the blanks) represents the main unit configured to interact directly with the article being processed, and in which the abutment element 24 is connected to the main unit by means of an articulated rod system 22.

The provision of the articulated rod system 22 transforms the movement trajectory of the main unit (the rod 21) into a corresponding movement trajectory M3 of the abutment element 24.

It should be noted that each point of the movement trajectory of the rod 21 corresponds to a specific position of the movement trajectory M3 of the abutment element 24 (in other words, the two trajectories are linked to each other by a bi-univocal function), so that both trajectories can represent the movement trajectory of the retaining device 20.

The retaining device 20 is moved into the operating position when the equipment 10 reaches the abutment zone B of the circular path F defined by the carousel 8.

In such a zone, in fact, the blank feeder 4 introduces a blank 7 into the circular path F in front of the mandrel 11, which, with the front wall 11a thereof, abuts a panel of the blank 7 to drag it therewith along the circular path F. In this step, the blank 7 is released from the blank feeder 4 and must be promptly retained against the front wall 11a of the mandrel 11 precisely by the retaining device 20 oscillated against the front wall 11a. It is therefore very important that there is a perfect synchronism between the blank feeder 4 and the retaining device 20, so that the rod 21 is oscillated against the mandrel 11 at the right time.

While the equipment 10 travels the forming zone C, the retaining device 20 remains in the operating position, while in the unloading zone D, where the mandrel 11 is extracted from the box before the latter is picked up from the unloading station 6, the retaining device 20 is moved in the non-operating position, where it also remains in the successive return zone E as well as in the feed zone A.

The movement trajectory M3 of the retaining device 20 is the result of the composition of the circular motion of the equipment 10 about the vertical rotation axis of the carousel 8 (uniform circular motion) with the oscillation motion induced by the electric motor 23 which moves the rod 21 to and from the front wall 11a of the mandrel 11.

The movement of the retaining device 20 in a non-operating position before the equipment 10 is located in the feed zone A, and the movement of the retaining device 20 in an operating position in the abutment zone B are considered particularly critical. In the first case, in fact, the retaining device 20 could interfere with the movement of the product feeder 3, causing an unwanted accident, and in the second case it could compromise the correct formation of the box around the mandrel 11.

To prevent such undesired events, the slide channel 25, representing the second auxiliary guide element, accommodates the roller 24 between a pair of walls 27 alongside the movement trajectory M3 at respective distances S2 and S3 which, point by point, are equal to an acceptable deviation of the roller 24 of the retaining device 20 from the movement trajectory M3 along the respective radial deviation directions (one oriented outwards and one inwards).

The distances S2 and S3 can be very small, for example a few millimetres (3-5 mm) or in some segments a few tens or hundreds of millimetres (10-200 mm).

The two walls 27 of the slide channel 25 thus represent two respective predefined safety trajectories T2 and T3 which allow the retaining device 20 to be mechanically guided so as to avoid any possible collision with the product feeder 3 and to bring the rod 21 against the mandrel 11 at the appropriate time.

In fact, if the roller 24 of the retaining device 20 deviates from the movement trajectory M3 along the radial direction X moving away from or approaching the rotation axis of the carousel 8 (for example due to an insufficient movement of the electric motor 23 or due to a delay in such a movement) by a distance equal to the deviation S2 or, respectively, S3, the roller 24 would touch the respective wall 27 of the slide channel 25 and the retaining device 20 would be guided by the second auxiliary guide element along the safety trajectory T2 or, respectively, T3.

The walls 27 of the slide channel 25 therefore represent respective cam profiles for the roller 24.

It should be noted that in the forming zone C the deviation S3, i.e., the acceptable deviation from the movement trajectory M3 directed radially towards the rotation axis of the carousel 8, is rather high, greater than the acceptable deviation in other zones of the circular path F. This is due to the fact that the maintenance of the retaining device 20 in the operating position in such a zone is not particularly critical and this advantageously allows the retaining device 20 to be moved to a non-operating position if the packaging apparatus 1 is stopped and a possible blank 7 retained between the mandrel 11 and the rod 21 must be removed.

As in the previous example, also in this case during the normal operation of the packaging apparatus 1, the retaining device 20 is moved along the movement trajectory M3 only by the rotary motion of the carousel 8 and the oscillating motion of the electric motor 23, without any interaction with the second auxiliary guide clement 25.

In fact, the latter would only intervene if the roller 24, e.g., due to some malfunction of the electric motor 23, should fail to move to the operating or non-operating position at the envisaged time or to the envisaged extent.

As in the previous example, also in this case, it is further envisaged that the contact between the roller 24 and the second auxiliary guide element 25 is also promptly detected, e.g., by monitoring an anomalous trend in the power absorbed by the electric motor 23 or in any other convenient manner. Following this detection, an alarm signal can be conveniently emitted and, preferably, a controlled shutdown of the packaging apparatus 1 can also be commanded, so that operators can perform the relevant checks and any maintenance.

A closing device 30 is further mounted on each equipment 10, is arranged to at least partially overlap and fix an outer flap of a blank 7 onto an inner flap of the same blank 7 when the blank is partially wrapped on the mandrel 11.

The closing device 30 comprises an abutting element 31 extended along the radial direction X and positioned upstream of the mandrel 11.

The closing device 30 is movable between a non-operating position, in which the abutting element 31 is spaced from the mandrel 11, and an operating position, in which the abutting element 31 is in a position such as to press the outer flap onto the inner flap and against a rear wall 11b of the mandrel 11. Thereby, thanks to the provision on one of the two flaps of a suitable amount of glue, the fixing of the outer flap on the corresponding inner flap is obtained and thus the formation of a laterally closed box.

In order to pass from the operating position to the non-operating position and vice versa, the abutting element 31 is translated along a straight path P which, with respect to the equipment 10, is comprised in a vertical plane and is inclined with respect to both the vertical and the horizontal direction.

The abutting element 31 is shaped like a rod, similarly to the rod 21 of the retaining device 20, and its translation along the straight path P is controlled by an electric motor 33, also mounted on the equipment 10, which acts on the abutting element 31 by means of a chain or belt type transmission 31a.

An abutment element, formed by a roller 34 mounted idle on an articulated rod system 32, is also configured to abut, if necessary, a third auxiliary guide element obtained in the load-bearing structure 9 of the carousel 8.

In particular, the third auxiliary guide clement is formed by a plurality of plates 35, integral with the load-bearing structure 9 and extended over some segments of a cylindrical surface coaxial with the rotation axis of the carousel 8.

The plates 35 have one or more shaped edges 36a, 36b which in at least a pair of segments face each other to define a first slide channel 36c and a second slide channel 36d, generally of variable width.

The articulated rod system 32 comprises a first rod 32a pivoted at a first end thereof to the abutting element 31 and a second rod 32b pivoted at a first end thereof to a second end of the first rod 32a and at a second end thereof opposite an upright 37 integral with the equipment 10 and spaced from the abutting element 31.

The roller 34 is mounted at the joint between the first rod 32a and the second rod 32b of the articulated rod system 32, preferably coaxially with such a joint.

The closing device 30 described herein represents a third example of an operating assembly according to the present solution, of which the abutting element 31 (which folds the flaps of the blank and presses them against the mandrel 11) represents the main unit configured to interact directly with the article being processed, and in which the abutment element 34 is connected to the main unit by means of the articulated rod system 32.

The provision of the articulated rod system 32 transforms the movement trajectory of the main unit (the abutting element 31) into a corresponding movement trajectory M4 of the abutment element 34.

As in the previous case, each point of the movement trajectory of the abutting clement 31 corresponds to a specific position of the movement trajectory M4 of the abutment element 34, so that both trajectories can be considered as the movement trajectory of the closing device 30.

The closing device 30 is moved into operating position when the equipment 10 is in the forming zone C of the circular path F defined by the carousel 8.

In the forming zone C, the mandrel 11 is conducted along the circular trajectory F, passing in the middle of a pair of fixed, horizontal and parallel plates 37a, 37b, which are suitably spaced from each other to abut two main panels 7a, 7b of the blank 7 and hold them in a folded position against an upper wall and a lower wall of the mandrel 11.

The upper plate 37a, in a precise point in the forming zone C, has an opening 38 which allows the abutting element 31 to enter between the two plates 37a and 37b so as to abut the outer flap of the blank 7, fold it against the respective inner flap and then press both against the rear part 11b of the mandrel 11.

The width of the opening 38 is as narrow as possible to ensure that the top panel of the blank is properly retained, whereby it is very important that the abutting element 31 is lowered in the operating position in a timely and precise manner.

While the equipment 10 travels the remaining part of the forming zone C, the closing device 30 remains in the operating position, so as to allow the glue to cure.

In the unloading zone D, where the mandrel 11 is extracted from the box 2a before the latter is picked up from the unloading station 6, the closing device 30 is moved in the non-operating position, where it also remains in the successive return zone E as well as in the feed zone A and the abutment zone B.

The movement trajectory M4 of the closing device 30 is the result of the composition of the circular motion of the equipment 10 about the vertical rotation axis of the carousel 8 (uniform circular motion) with the translation motion induced by the electric motor 33 which moves the abutting element 31 to and from the rear wall 11b of the mandrel 11.

As mentioned above, the movement of the closing device 30 into operating position in the forming zone C is considered particularly critical.

In fact, if the abutting element 31 does not pass through the opening 38 at the right time, the abutting element 31 could interfere with the upper plate 37a causing an unwanted accident.

The movement of the closing device 30 into the non-operating position in the unloading zone D is considered similarly critical.

In fact, if the abutting element 31 were not lifted in a timely manner, it could interfere with the gripping members 6a of the unloading unit 6 and/or the gripping members 3a of the product feeder 3, causing an undesired collision.

To prevent such undesirable events, the plate 35 representing the third auxiliary guide element comprises the first and the second slide channel in which the roller 34 is accommodated, defining the walls of the slide channels. The shaped edges 36a and 36b flank the movement trajectory M4 at respective distances S4 and S5 which, point by point, are equal to an acceptable deviation of the roller 34 of the closing device 30 from the movement trajectory M4 along the respective deviation directions.

The distances S4 and S5 within the slide channels 36c and 36d can be very small, e.g., they can range from a few millimetres (3-5 mm) to a few tens of millimetres (10-30 mm), while outside the slide channels, the distances to the possible shaped edge 36a or 36 can also be larger, e.g., from a few tens of millimetres to even a few hundred millimetres (10-400 mm).

The shaped edges 36a and 36b thus represent two respective predefined safety trajectories T4 and T5 which allow the closing device 30 to be mechanically guided so as to avoid any possible collision with the plate 37a, bringing the abutting element 31 against the mandrel 11 at the appropriate time.

In fact, if the roller 34 of the closing device 30 deviated from the movement trajectory M4 (e.g., due to an insufficient movement of the electric motor 33 or a delay in such movement) by a distance equal to the deviation S4 or, respectively, S5, the roller 34 would touch the respective shaped edge 36a or 36b of the slide channel 36c or 36d and the closing device 30 would be guided by the third auxiliary guide element along the safety trajectory T4 or, respectively, T5.

The shaped edges 36a and 36b of the plates 35 therefore represent respective cam profiles for the roller 34.

As in the previous examples, during the normal operation of the packaging apparatus 1, the closing device 30 is moved along the movement trajectory M4 only by the rotary motion of the carousel 8 and the translation motion of the electric motor 33, without any interaction with the third auxiliary guide element 35.

In fact, the latter would only intervene if the roller 34, e.g., due to some malfunction of the electric motor 33, should fail to move correctly towards the operating position at the envisaged moment.

As in the previous example, also in this case, it is further envisaged that the contact between the roller 34 and the third auxiliary guide element 35 is also promptly detected, e.g., by monitoring an anomalous trend in the power absorbed by the electric motor 33 or in any other convenient manner. Following this detection, an alarm signal can be conveniently emitted and, preferably, a controlled shutdown of the packaging apparatus 1 can also be commanded, so that operators can perform the relevant checks and any maintenance.

All the movement trajectories M1-M4 of the operating assemblies described above are conveniently stored in a control unit of the packaging apparatus 1, not illustrated in the enclosed figures, duly connected with the respective electric motors 13, 23, 33 which provide for their movement.

This solution thus solves the technical problem identified above, while at the same time obtaining further advantages, including the possibility of adjusting the operating parameters of the operating assembly by means of electric motors, while maintaining the precision and safety of mechanical process management.

Obviously, a person skilled in the art may, in order to meet specific and contingent application requirements, make further modifications and variants to the solution described above, all falling within the scope of protection as defined by the following claims.

1.-20. (canceled)

21. A method for controlling a movement of an operating assembly of an apparatus for the automatic processing of articles, comprising:
defining a movement trajectory of said operating assembly configured to perform a processing on an article of said articles,
defining, for at least one segment of said movement trajectory, a deviation of said operating assembly from said movement trajectory, such that said operating assembly can be moved in safe conditions,
defining, in said at least one segment of said movement trajectory, a safety trajectory alongside said movement trajectory at a distance substantially equal to said deviation,
configuring an electric motor to move said operating assembly along at least a portion of said movement trajectory,
arranging an auxiliary guide element at said safety trajectory,
moving said operating assembly by said electric motor along at least a portion of said movement trajectory, and
abutting said operating assembly with said auxiliary guide element to control the movement of said operating assembly by guiding it along said safety trajectory by said auxiliary guide element if, along said at least one segment of said movement trajectory, said operating assembly moves away from said movement trajectory by a distance equal to said deviation.

22. The method according to claim 21, wherein said deviation is variable based on a position of said operating assembly along said at least one segment of the movement trajectory.

23. The method according to claim 21, wherein said deviation is variable based on a direction of deviation of said operating assembly from said movement trajectory.

24. The method according to claim 21, further comprising:
detecting when said operating assembly is abutted by said auxiliary guide element.

25. The method according to claim 24, further comprising:
after said detecting, sending an alarm signal when said operating assembly is abutted by said auxiliary guide element.

26. The method according to claim 24, further comprising:
after said detecting, stopping the movement of said operating assembly.

27. The method according to claim 24, wherein said detecting comprises:
measuring an operating parameter of said electric motor and
comparing a measured value of said operating parameter with a standard value of said operating parameter.

28. The method according to claim 21, wherein said operating assembly is mounted on an equipment of said apparatus, said equipment being movable with respect to a load-bearing structure of said apparatus, and said method further comprises:
moving said equipment along a main trajectory, and
moving said operating assembly in relation to said equipment while moving said equipment along said main trajectory.

29. The method according to claim 28, wherein said main trajectory is circular.

30. The method according to claim 28, wherein said operating assembly is moved in relation to said equipment by a translation movement.

31. An apparatus for automatic processing of articles, comprising:
an operating assembly configured to interact with an article of said articles and to perform said processing, and movable along a predefined movement trajectory,
an electric motor configured to move said operating assembly along at least a portion of said movement trajectory,
an auxiliary guide element alongside said movement trajectory at at least one segment of said movement trajectory,
wherein said auxiliary guide element is:
spaced from said movement trajectory by a distance equal to a deviation of said operating assembly from said movement trajectory such that said operating assembly can be moved in safe conditions, and
configured to abut said operating assembly when said operating assembly moves away from said movement trajectory by a distance equal to said deviation, and to guide said operating assembly along a safety trajectory.

32. The apparatus according to claim 31, wherein said operating assembly is mounted on an equipment of said apparatus, said equipment being movable with respect to a load-bearing structure of said apparatus.

33. The apparatus according to the claim 32, wherein said load-bearing structure is fixed and said equipment rotates about a fixed rotation axis passing through said load-bearing structure.

34. The apparatus according to claim 32, wherein a plurality of equipment is mounted on said load-bearing structure, each equipment provided with a respective operating assembly.

35. The apparatus according to claim 32, wherein said auxiliary guide element is integral with said load-bearing structure.

36. The apparatus according to claim 31, wherein said operating assembly comprises an abutment element configured to abut said auxiliary guide element when said operating assembly moves away from said movement trajectory by the distance equal to said deviation.

37. The apparatus according to claim 36, wherein said abutment element comprises a roller configured to roll on said auxiliary guide element.

38. The apparatus according to claim 36, wherein said abutment element is integrally connected to a main unit of said operating assembly, said main unit configured to perform said processing on said article. Page 7

39. The apparatus according to claim 36, wherein said abutment element is connected to a main unit of said operating assembly, said main unit configured to perform said processing on said article by an articulated rod system.

40. The apparatus according to claim 31, wherein said auxiliary guide element comprises a slide channel wherein a respective wall of said slide channel is arranged at a distance from said movement trajectory equal to said deviation along a defined deviation direction between said movement trajectory and said respective wall.
